(19) United States
(12) Patent Application Publication
(10) Pub. No.: US 2026/0336447 A1
(43) Pub. Date: Oct. 29, 2026

(54) METHOD FOR AUTONOMOUS CHARGING OR FUELING A VEHICLE, AUTONOMOUS CHARGING OR FUELING A VEHICLE, AND CHARGING OR FUELING STATION

(71) Applicant: Robert Bosch GmbH, Stuttgart (DE)

(72) Inventor: Hubert Straub, Tuebingen (DE)

(21) Appl. No.: 19/103,995

(22) PCT Filed: Jul. 27, 2023
(86) PCT No.: PCT/EP2023/070806

§ 371 Date: Feb. 14, 2025

(30) Foreign Application Priority Data
Aug. 16, 2022 (DE) 10 2022 208 497.7

(51) Int. Cl. B60L 53/36; B60L 53/37; B60L 53/62; B60L 53/65; B60L 53/66

(52) U.S. Cl. CPC B60L 53/36; B60L 53/37; B60L 53/62; B60L 53/65; B60L 53/66

(57) ABSTRACT

The invention relates to a method for autonomous charging or fueling of a vehicle, comprising the steps of
(S1) detecting an autonomous charging or fueling of a vehicle in a charging or fueling position at a charging or fueling station,
(S2) exchanging data between the vehicle and the charging or fueling station and translating the data into control instructions for the charging or fueling station,
(S3) establishing a connection between the charging or fueling station and the vehicle, said connection enabling an energy transfer or media transfer,
(S4) performing the charging or fueling process,
(S5) disconnecting the connection between the charging or fueling station and the vehicle that enables the energy or media transfer.

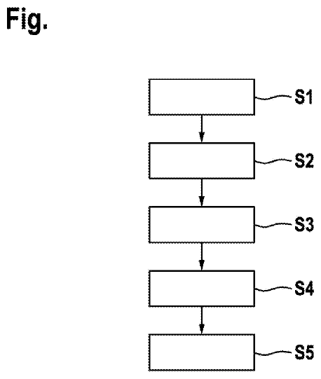

The invention further relates to an autonomous charging or fueling vehicle, and to a charging or fueling station for such a vehicle.

### BACKGROUND

The invention relates to a method for autonomous charging or fueling a vehicle. In particular, the vehicle may be an autonomously driving vehicle that independently approaches a charging or fueling station, if needed. In addition, the invention further relates to an autonomous charging or fueling vehicle, and to a charging or fueling station for an autonomous charging or fueling vehicle.

Autonomously or at least partially autonomously driving vehicles are known. They represent a current focus in the development of freight and passenger transport. The type of drive of autonomously driving vehicles is often electrical, wherein the required electrical energy is provided via a battery and/or generated on board the vehicle, in particular with the aid of fuel cells. Alternatively, fuels or combustibles may be used as an energy source, which are then burned in an internal combustion engine.

Regardless of the type of drive, vehicles must therefore be charged or fueled at certain time intervals, wherein not only fueling with fuels or combustibles but also fueling with an auxiliary substance, such as a reducing agent for exhaust aftertreatment, may be required. The vehicle must therefore repeatedly approach an appropriate charging or fueling station. In this context, in particular in the case of an autonomously driving and thus driverless vehicle, it would be desirable for the vehicle to be able to independently perform the charging or fueling process.

### SUMMARY

This problem is addressed by the present invention. In particular, a method for autonomous charging or fueling, an autonomous charging or fueling vehicle, and a charging or fueling station for such a vehicle are to be specified.

The proposed method for autonomous charging or fueling a vehicle comprises the steps of:
(S1) detecting an autonomous charging or fueling vehicle in a charging or fueling position at a charging or fueling station,
(S2) exchanging data between the vehicle and the charging or fueling station and translating the data into control instructions for the charging or fueling station,
(S3) establishing a connection between the charging or fueling station and the vehicle, said connection enabling an energy transfer or media transfer,
(S4) performing the charging or fueling process,
(S5) disconnecting the connection between the charging or fueling station and the vehicle that enables the energy transfer or media transfer.

Charging or fueling the vehicle can thus be carried out independently, in particular without intervention of a person. That is to say, in particular, a driverless or autonomously driving vehicle. Furthermore, the charging or refueling of the vehicle does not require a service employee, such as a fuel attendant, to eliminate labor costs. The charging or fueling process can be carried out around the clock, i.e. 24 hours a day and 7 days a week, so that the investment costs should be amortized after a short period of time.

If the autonomous charging or fueling vehicle is controlled by a driver, the driver does not need to get out of the vehicle for charging or refueling, as this process takes place independently.

The performance of the method requires a vehicle that is suitable for autonomous charging or fueling. If this is the case, the vehicle preferably receives an identifier, which is detected or recognized by the vehicle upon approaching the charging or fueling station. Instead of a separate identifier, an electronic interface via which the vehicle can communicate with the charging or fueling station can also be used to identify the vehicle. The electronic interface can then be used to transmit further data to the charging or fueling station which is required to perform the charging or fueling process, for example information on the type and amount of fuel or information on a particular type of plug. Furthermore, data for locating the tank filler neck or plug receptacle may be communicated. Alternatively or in addition, fiducial marks may be used for locating.

The performance of the method also requires a charging or fueling station suitable for autonomous charging or fueling a vehicle. Analogously to the vehicle, the charging or fueling station must also have an electronic interface for communication with the vehicle. Moreover, the charging or fueling station requires a standard interface for energy transfer or media transfer from the charging or fueling station to the vehicle, for example in the form of a plug or a dispensing valve. The standardization of the interface is intended to ensure compatibility with a corresponding interface of the vehicle, for example in the form of a plug receptacle or a tank filler neck. Such a standard interface is usually already present on the vehicle. However, a completely new interface can also be created, which then forms the standard for autonomous charging or fueling.

The electronic interface may be wireless, for example via WLAN, Bluetooth, a mobile radio standard or another standard, or by direct electrical contact, for example by means of a plug.

Data exchange via the electronic interface is usually not sufficient. Because the data must first be translated into corresponding control instructions for the charging or fueling station in order to start the actual charging or fueling process. Furthermore, a connection must be established between the charging or fueling station and the vehicle that allows for energy transfer or media transfer from the charging or fuel station to the vehicle. Depending on the type of drive of the vehicle, electrical energy is then transferred via the established connection or a medium, in particular a fuel or combustible, to the vehicle. The connection can therefore in particular be established via a plug contact or a tank valve and a tank filler neck. If the connection is established, the vehicle, in particular an energy store or tank of the vehicle, can be charged or fueled. If the charging or fueling process is complete, the connection is disconnected again.

In the further development of the invention, it is proposed that in at least one of the steps S1 to S5 of the proposed method, an optical monitoring and/or control system comprising at least one camera and/or one sensor is used. With the aid of the optical monitoring and/or control system, the charging or fueling process can be monitored. Furthermore, the system may be utilized to detect an autonomous charging or fueling vehicle and/or to detect and/or locate the standard interface of the vehicle. When establishing the connection between the energy or media transfer and the vehicle, said connection enabling the energy transfer or media transfer, the monitoring and/or control system can be used to monitor and/or control the processes. If the monitoring and/or control system comprises a sensor, position control measurements may also be taken, for example by means of LIDAR or in an ultrasonic manner.

Advantageously, a suitable charging or fueling position of the vehicle is found with the aid of an electronic guidance system. For example, with the aid of the guidance system, a suitable and preferably free charging or fueling station can be assigned to the vehicle so that no waiting period is incurred. The guidance system may use a coordinate system and/or GPS data of a navigation system of the vehicle. Preferably, the guidance system is automatically activated when an autonomous charging or fueling vehicle approaches the charging or fueling station.

Reaching the assigned charging or fueling position may in turn be monitored with the aid of the optical monitoring and/or control system.

If the vehicle is in the charging or fueling position assigned to it or at least at a suitable charging or fueling position, the connection between the charging or fueling station and the vehicle that enables energy transfer or media transfer is preferably established in the next step, preferably with the aid of a robot, in particular a robotic arm. This guides the plug to the plug receptacle or the tank valve to the tank neck filler and thus replaces the tank attendant. Depending on the accessibility of the standard interface required for establishing the connection, a protective cap, a closing flap and/or a tank lock can be opened beforehand with the aid of the robot, which is then closed again with the aid of the robot after the charging or fueling process. Alternatively or in addition, the connection between the charging or fueling station and the vehicle may also be established with the aid of at least one mechanical component, for example a conveyor belt, a linear guide, a mechanical gripper, a suction cup, or the like. If a robot is used, it may comprise one or more arms and/or operate one or more charging or fueling stations.

The opening and closing of a protective cap, a closing flap and/or a tank lock may also be carried out by the vehicle itself. Preferably, it receives a signal indicative of the vehicle having reached a charging or fueling position. The automatic opening and closing by the vehicle has the advantage that manipulation from the outside is difficult, which can range from damage to the vehicle to fuel theft.

If the vehicle opens the protective cap, flap and/or tank lock automatically, the standard interface of the vehicle for energy transfer or media transfer from the charging or fueling station only needs to be located. This can be done, for example, with the aid of fiducial marks or fiducial structures arranged in the area of the interface. Suitable fiducial structures may be, for example, pins or brackets. Their position can be detected with the aid of the optical monitoring and/or control system, which preferably comprises at least one camera.

As already mentioned, the connection enabling energy transfer or media transfer does not necessarily have to be established via already standard interfaces, but new interfaces and thus new standards can also be created for autonomous charging or fueling. As an example, reference is made to the already standard interfaces in aerial fueling of aircraft. That is, the vehicle may also have a movable, for example extendable, interface for connection to the interface of the charging or fueling station. The extension could be realized telescopically or by means of a movable arm. Alternatively or in addition, the interface of the charging or fueling station may be arranged on a telescopic and/or movable arm to establish the necessary connection.

Preferably, after performing the charging or fueling process, a payment process is performed. For payment, data is preferably exchanged between the charging or fueling station and the vehicle via an electronic interface. For example, the data may be bank details, a credit card number, or data from an online payment service. A separate payment system can also be created for this process.

Payment is preferably preceded by a request for payment. At the same time, by maintaining the connection for energy transfer or media transfer, the vehicle may be prevented from driving away until the payment process is complete.

Furthermore, an autonomous charging or fueling vehicle is proposed to perform the method according to the invention. The vehicle has:
an energy store, for example in the form of a battery or tank,
a standard interface connected to the energy store via a line, for example in the form of a plug receptacle or a tank filler neck, which is preferably accessible from the outside and/or can be located with the aid of fiducial marks and/or structures,
an electronic interface for communicating the vehicle with a charging or fueling station.

One essential feature of the autonomous charging or fueling vehicle is the electronic interface for communicating with a charging or fueling station. The vehicle can use this to identify itself as an autonomous charging or fueling vehicle. Furthermore, it may transmit information to the charging or fueling station about the type and/or amount of energy or medium required. This may then be translated into control instructions that cause the charging or fueling station to initiate the charging or fueling process.

Charging or fueling requires a connection between the charging or fueling station and the vehicle that enables energy transfer or media transfer. For this purpose, the vehicle has a standard interface, for example in the form of a plug receptacle or a tank filler neck. However, it may also be a new interface that represents a new standard for autonomous charging or fueling. Advantageously, the interface is accessible from the outside so that the necessary connection to the charging or fueling station can be established. Furthermore, it must also be possible to locate the interface, wherein fiducial marks and/or structures arranged at the interface may be helpful.

The charging or fueling station then comprises corresponding means for detecting the fiducial marks and/or structures.

According to a preferred embodiment of the invention, the vehicle has an identifier that identifies the vehicle to the charging or fueling station as an autonomous charging or fueling vehicle. For example, the identifier may be stored in an RFID transponder that may be read by the charging or fueling station.

Moreover, a charging or fueling station for an autonomous charging or fueling vehicle, that is to say for carrying out the method according to the invention, is proposed. The charging or fueling station comprises:
a standard interface for energy transfer or media transfer from the charging or fueling station to the vehicle, for example in the form of a plug or a dispensing valve,
an electronic interface for communication between the charging or fueling station and the vehicle.

The necessary connection to the vehicle for energy transfer or media transfer can be established via the standard interface. This need not be a pre-determined standard, but may also be a completely new standard specifically for autonomous charging or fueling. The necessary data exchange with the vehicle takes place via the electronic interface. In particular, information about the vehicle, the type of drive, the required energy or the required medium can be received via the electronic interface.

According to a preferred embodiment of the invention, the standard interface is arranged on a movable arm, in particular on a robotic arm. In order to establish the connection of the charging or fueling station to the vehicle that enables the energy transfer or media transfer, the interface can then be connected to the corresponding interface of the vehicle. For example, if the standard interface is a plug, it may be inserted into a corresponding plug receptacle of the vehicle. The charging or fueling station may also have a plurality of movable arms so that a plurality of vehicles can be charged or fueled simultaneously.

Further preferably, the charging or fueling station comprises an optical monitoring and/or control system comprising at least one camera and/or sensor. With the aid of the optical monitoring and/or control system, the entire charging or fueling process can be monitored. In particular, it can be checked whether the vehicle has a suitable charging or fueling position and/or whether the connection necessary for the energy transfer or media transfer is correctly established. The monitoring and/or control system may further be used to locate the vehicle and/or the standard interface of the vehicle.

The invention and its advantages are explained in further detail below with reference to the accompanying FIGURE. This shows s preferred workflow of a method according to the invention.

### BRIEF DESCRIPTION OF THE DRAWING

Based on the FIGURE, only the essential steps of a method according to the invention are described, which comprise steps S1 to S5. Moreover, further steps may be provided.

### DETAILED DESCRIPTION

To perform a charging or fueling process, in step S1, an autonomous charging or fueling vehicle must first be detected in a charging or fueling position at a charging or fueling station. If the vehicle has not occupied a proper charging or fueling position, it may need to be directed to one. A guidance system may be provided for this purpose, which is automatically activated when an autonomous charging or fueling vehicle approaches the charging or fueling station.

In step S2, the vehicle and the charging or fueling station exchange data, which may include, in particular, information about the energy or medium required and/or the standard interface. If this information is needed to allocate a particular charging or fueling station and/or a particular charging or fueling position, step S2 may also be performed prior to activation of the guidance system. The data transmitted from the vehicle to the charging or fueling station is then translated into control instructions for the charging or fueling station, which initiate the actual charging or fueling process.

To this end, a connection between the charging or fueling station and the vehicle is first established that enables energy transfer or media transfer. The connection may be established, for example, by means of a plug and a plug receptacle or a tank valve and a tank filler neck. Establishing a correct connection may be monitored with the aid of an optical monitoring and/or control system.

If the connection is established, the charging or fueling process can be performed in step S4. When charging, for example, a vehicle battery is supplied with electrical energy. When fueling, a tank of the vehicle is filled with a medium, which may in particular be a fuel or a combustible. However, the medium may also be an auxiliary substance, for example a reducing agent for exhaust aftertreatment.

The end of the charging or fueling process operation may be determined as desired. It does not necessarily have to be the time when the battery is fully charged or the tank is fully filled. It may also be a charging or fueling process limited in time and/or quantity. In this case, the charging or fueling station preferably signals to the vehicle that the charging or fueling process is complete. Furthermore, the charging or fueling station may request the vehicle to pay.

After completion of the charging or fueling process, preferably after payment, the connection between the charging or fueling station and the vehicle that enables the energy or media transfer is then disconnected again in step S5. The vehicle may subsequently resume its travel.

1. A method for autonomous charging or fueling of a vehicle, comprising the steps of
(S1) detecting an autonomous charging or fueling of a vehicle in a charging or fueling position at a charging or fueling station,
(S2) exchanging data between the vehicle and the charging or fueling station and translating the data into control instructions for the charging or fueling station,
(S3) establishing a connection between the charging or fueling station and the vehicle, said connection enabling an energy transfer or media transfer,
(S4) performing the charging or fueling process, and
(S5) disconnecting the connection between the charging or fueling station and the vehicle, said connection enabling the energy transfer or media transfer.

2. The method according to claim 1, wherein, an optical monitoring and/or control system, comprising at least one camera and/or a sensor, is used for detecting the vehicle and/or establishing the connection between the charging or fueling station and the vehicle that enables the energy transfer or media transfer.

3. The method according to claim 1, wherein a suitable charging or fueling position of the vehicle is found with the aid of an electronic guidance system, which is preferably automatically activated when an autonomous charging or fueling vehicle approaches the charging or fueling station.

4. The method according to claim 1, wherein the connection between the charging or fueling station and the vehicle that enables the energy transfer or media transfer is established with robotic arm. (Currently Amended) The method according to claim 1, wherein after performing the charging or fueling operation, a payment operation is performed, wherein data is exchanged between the charging or fueling station and the vehicle via an electronic interface.

6. An autonomous charging or fueling vehicle comprising
an energy store,
a standard interface connected to the energy store via a line in the form of a plug receptacle or a tank filler neck, which is accessible from the outside and/or includes fiducial marks and/or fiducial structures, and
an electronic interface for communicating the vehicle with a charging or fueling station.

7. The vehicle according to claim 6, wherein the vehicle has an identifier that identifies the vehicle to the charging or fueling station as an autonomous charging or fueling vehicle.

8. A charging or fueling station for an autonomous charging or fueling vehicle, comprising
a standard interface for energy transfer or media transfer from the charging or fueling station to the vehicle,
an electronic interface for communication between the charging or fueling station and the vehicle.

9. The charging or fueling station according to claim 8, wherein the standard interface is arranged on a movable arm.

10. The charging or fueling station according to claim 8, further comprising an optical monitoring and/or control system having at least one camera and/or sensor.
